(19) United States
(12) Patent Application Publication
(10) Pub. No.: US 2026/0369661 A1
(43) Pub. Date: Nov. 19, 2026

(54) SOLID-STATE HIGH-ENERGY-DENSITY LITHIUM BATTERY SYSTEM

(71) Applicant: Venkata S Reddy Channu, Ann Arbor, MI (US)

(72) Inventor: Venkata S Reddy Channu, Ann Arbor, MI (US)

(21) Appl. No.: 19/664,596

(22) Filed: Apr. 30, 2026

Related U.S. Application Data
(60) Provisional application No. 63/805,205, filed on May 13, 2025.

(51) Int. Cl. H01M 10/056; H01M 4/02; H01M 4/485; H01M 4/525; H01M 10/052; H01M 50/107; H01M 50/457

(52) U.S. Cl. CPC H01M 10/056; H01M 4/485; H01M 4/525; H01M 10/052; H01M 50/107; H01M 50/457; H01M 2004/027; H01M 2004/028; H01M 2300/0034; H01M 2300/0037; H01M 2300/0068; H01M 2300/0082

(57) ABSTRACT

A solid-state battery capable of safe and efficient operation under extreme temperature conditions is disclosed. The battery includes a lithium-based solid-state anode, a lithium-based solid-state cathode, and a quasi-solid-state electrolyte. The quasi-solid-state electrolyte includes a room-temperature ionic liquid, a lithium salt, a clay additive, and ethyl methyl carbonate. The anode comprises lithium titanium oxide (Li₄Ti₅O₁₂), optionally provided as a carbon-coated or graphene-coated composite, and the cathode comprises LiNi_{0.8}Mn_{0.1}Co_{0.1}O₂.

### CROSS REFERENCE TO RELATED APPLICATIONS

This application claims priority from a U.S. Provisional Patent Appl. No. 63/805,205, filed on May 13, 2025, which is incorporated herein by reference in its entirety.

### FIELD OF INVENTION

The present invention relates to lithium-based electrochemical energy storage systems, and more particularly to quasi-solid-state or solid-state lithium batteries incorporating lithium titanate anodes, high-nickel cathodes, and ionic-liquid-based clay-modified electrolytes for enhanced safety, thermal stability, and high energy density.

### BACKGROUND

Batteries have become a critical means of energy storage in the modern world. The importance of battery technologies has increased significantly due to the global transition toward greener and renewable energy sources, such as solar and wind power. The adoption of electric vehicles continues to rise and is expected to progressively replace fuel-based vehicles with batteries forming the core energy source for such vehicles. Additionally, numerous engineering fields and applications are emerging or expanding that rely heavily on battery-based energy storage systems. Accordingly, battery technologies represent a substantial portion of current global research and development investment.

Despite substantial advancements, certain areas of battery technology remain underdeveloped, particularly batteries capable of reliable operation under extreme environmental conditions. Most commercially available batteries are designed to operate within a relatively narrow temperature range, typically from approximately −20 °C to 40 °C. However, many applications require batteries to function under significantly more severe temperature conditions. For example, batteries used in military, aerospace, industrial, or remote-environment equipment may be exposed to temperatures exceeding 90 °C or falling below −35 °C, conditions under which conventional battery technologies may suffer from reduced performance, safety risks, or failure.

Accordingly, there exists a need for improved battery technologies that are capable of safe, reliable, and efficient operation across extreme temperature ranges, while maintaining high energy density and long operational life.

### SUMMARY OF THE INVENTION

The following provides a simplified summary of one or more embodiments of the present invention to facilitate a basic understanding of its features and advantages. This summary is not an exhaustive overview of all contemplated embodiments and is not intended to identify essential elements or define the full scope of the invention. It merely introduces certain concepts that are described in greater detail in the subsequent sections.

The principal object of the present invention is to provide a lithium-safe, high-energy-density battery meeting four critical performance metrics: intrinsic safety, ampere-hour (Ah) capacity, charge/discharge rate, and total system weight.

Another object of the present invention is to provide a battery suitable for military and mission-critical applications, including operation in environments characterized by elevated and sub-zero temperatures.

Yet another object of the present invention is to provide a high-energy-density solid-state battery capable of delivering enhanced power and extended operational life.

A further object of the present invention is to provide a scalable, safe, and high-performance energy storage solution suitable for a wide range of applications.

Another object of the present invention is that the battery can be used in Patriot JetBoot Diver Propulsion System (JDPS).

In one aspect, disclosed is a quasi-solid-state lithium battery system comprising a lithium titanate (Li₄Ti₅O₁₂) anode, a cathode comprising LiNi_{0.8}Mn_{0.1}Co_{0.1}O₂, and a quasi-solid-state electrolyte comprising a room temperature ionic liquid (RTIL), an organic carbonate diluent, and a clay or ceramic oxide additive; and a tri-layer separator optimized for wettability.

In one aspect, the electrolyte comprises 80 wt. % 1-methyl-1-propylpiperidinium bis(trifluoromethylsulfonyl)imide (Pip RTIL), 20 wt. % ethyl methyl carbonate (EMC), and ~0.5 wt. % clay additive. The clay-ionic liquid composite forms a quasi-solid-state electrolyte exhibiting improved ionic conductivity, reduced flammability, enhanced interfacial stability, improved wettability with polymer separators, and reduced polarization after formation cycles.

In one aspect, the system demonstrates high Coulombic efficiency (>99%), stable cycling at 0 °C to 50 °C, and intrinsic lithium safety.

In one aspect, the anode is graphene or carbon-coated. The electrolyte is solid-state or quasi-solid-state.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 illustrates XRD patterns of pure phase spinel Li₄Ti₅O₁₂ nanostructures.

FIG. 2 illustrates XRD patterns of LiNi_{0.8}Mn_{0.1}Co_{0.1}O₂ nanostructures.

FIG. 3 illustrates the tri-layer separator wettability in the quasi-solid-state electrolyte.

FIG. 4 illustrates a digital image of the pouch cells 1, 2, and 3.

FIG. 5 illustrates Charge/discharge profiles of 3.5 Ah Pouch Cell 1 with configuration of graphite/80% RTIL+20% EMC/NMC811 at RT °C with 1 C charge/discharge rate.

FIG. 6 illustrates Charge/discharge profiles of 3.5 Ah Pouch Cell 2 with configuration of graphite/80% RTIL+20% EMC/NMC 811 at RT °C with 1 C charge/discharge rate.

FIG. 7 illustrates Charge/discharge profiles of 3.5 Ah Pouch Cell 3 with configuration of graphite/80% RTIL+20% EMC/NMC811 at RT °C with 1 C charge/discharge rate.

FIG. 8 illustrates a digital image of the 18650 cylindrical cells.

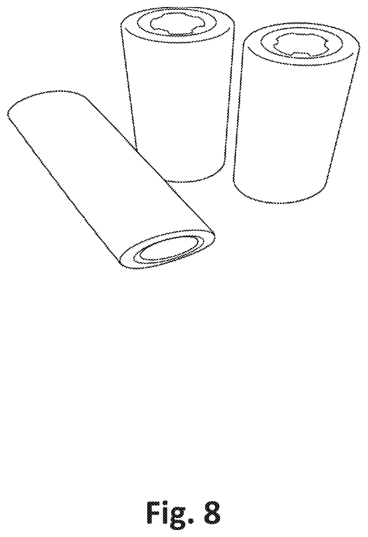

FIG. 9 illustrates charge/discharge characteristics of the 3.5 Ah 18650 Cell 1 with configuration of LTO/80% RTIL+20% EMC/NMC811.

FIG. 10 illustrates Charge/discharge characteristics of the 3.5 Ah 18650 Cell 2 with configuration of LTO/80% RTIL+20% EMC/NMC811.

FIG. 11 illustrates Charge/discharge characteristics of the 3.5 Ah 18650 Cell 2 with configuration of LTO/80% RTIL+20% EMC/NMC811.

FIG. 12 illustrates the cycle performance of the 3.5 Ah 18650 Cell 1 with a configuration of LTO/80% RTIL+20% EMC/NMC811 at RT °C with 0.5 C charge/1 C discharge rate.

FIG. 13 illustrates the first five Charge/discharge profiles of the 7S15P Battery Pack 9 with a 0.5 C (26A) rate at RT.

FIG. 14 illustrates twenty cycles of Charge/discharge performance of 7S15P Battery Pack 9 with a 0.5 C (26A) rate at RT.

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

In one aspect, disclosed is a solid-state high-energy density battery and a method of fabricating the same. The Solid-State High Energy Density Batteries are fabricated with and without graphene-coated or carbon-coated anode material of Li₄Ti₅O₁₂ (LTO), Quasi-Solid-State Electrolyte or solid-state electrolyte, and LiNi_{0.8}Mn_{0.1}Co_{0.1}O₂ (NMC811) cathode. The quasi-solid-state electrolyte includes Li₇La₃Zr₂O₁₂, Li_{6.4}Ta_{0.6}La₃Zr_{1.4}O₁₂, Li_{6.4}Ga_{0.2}La₃Zr₂O₁₂, and Li_{6.25}Ga_{0.25}La₃Zr₂O₁₂ powders. The measured ionic conductivity of Li_{6.4}Ta_{0.6}La₃Zr_{1.4}O₁₂ was 6.6×10⁴ S/cm. Transmission electron microscopy results reveal a cloth-type structure of graphene oxide (GRO) and graphene (GR) with a thickness of 10 nm. XRD results of the LTO anode show the pure phase of the spinel L₄Ti₅O₁₂. EDXA spectrum of Graphene-coated LTO anode revealed carbon richness. The impedance spectra of the quasi-solid-state electrolyte confirms that the resistance involved in the polarizable Li—Li configuration is less resistive at high temperature compared to room temperature. Interestingly, the Al₂O₃ added composition gives better impedance compared to the blank room temperature ionic liquid (RTIL) with quartz separator. This observation is due to the better electrolyte channeling in the Al₂O₃ incorporated RTIL. RTIL/Clay systems perform better than RTIL/Al₂O₃ systems in terms of ionic conductivity and stability.

Based on the optimized electrolyte, half cells and full cells were fabricated using Li/quasi-solid-state electrolyte/Lithium Titanate (Li₄Ti₅O₁₂) and/or LTO/graphene and Li/quasi-solid-state electrolyte/NMC811, and a full cell of graphene-coated LTO/quasi-solid-state electrolyte/NMC811. The fabricated cells were characterized by Arbin instruments at different cycling rates. In full cells, the first cycle lithiation/de-lithiation is crucial because that process tries to establish a better electrode-electrolyte interface.

High nickel NMC811 was coupled with graphene-coated LTO anode using an optimized quasi-solid-state electrolyte based on Clay and Piperidinium ionic liquid. Voltage profiles of NMC811/GR-LTO cells clearly show that the lithiation and de-lithiation reactions are highly reversible at extreme temperature (100 °C). However, initial voltage profiles exhibit ohmic polarization, but the continuous charge-discharge cycles improve the polarization effects. This observation is mainly due to the in-situ formation of a robust interface between electrodes and quasi-solid electrolytes. Interestingly, the interface establishment is achieved within ten cycles, and the observed ohmic drop is less compared to the initial cycles. Electrode material loading is ~15 mg/cm². This high loading is also one of the reasons for the polarization. After the 10th cycle, the cell exhibited less polarization, and constantly the charge discharge profiles showed improved voltage profiles, especially with less changes in cycle-to-cycle polarization effect. This behavior clearly confirms that the electrodes needed a few initial cycles to establish better interfacial contact with the quasi-solid-state electrolytes at high-temperature operation.

### Example 1—Preparation of Quasi-Solid-State Electrolyte Using Ceramic Oxide Filler

A room temperature ionic liquid (RTIL) was combined with aluminum oxide (Al₂O₃) in a volume-to-weight ratio of approximately 1:1 to form a homogeneous slurry. The mixture was mechanically blended in an agate mortar until uniform. The resulting slurry was cast onto a metallic coin-cell spacer to form an electrolyte layer having a thickness of approximately 250 micrometers, as measured using a precision caliper. The formed quasi-solid-state electrolyte membrane was utilized directly for coin-cell assembly and electrochemical evaluation. Electrolytes containing 0.8 M and 1.0 M lithium salt in the RTIL were evaluated at room temperature and at approximately 100 °C. In certain embodiments, the RTIL comprised 1-methyl-1-propylpiperidinium bis(trifluoromethylsulfonyl)imide.

### Example 2—Preparation of Clay-Based Quasi-Solid-State Electrolyte

Vacuum-dried bentonite clay was mixed with RTIL containing approximately 1.0 M lithium bis(trifluoromethylsulfonyl)imide at a weight ratio of about 1:1. The mixture was ground in an agate mortar until a uniform slurry was obtained. The slurry was cast onto a coin-cell spacer to form a quasi-solid-state electrolyte layer having a thickness of approximately 200 micrometers. Thickness was monitored using a precision caliper. The electrolyte membrane was subsequently employed in electrochemical test cells.

### Example 3—Solid-State Synthesis of Lithium Titanate (Li₄Ti₅O₁₂)

Lithium titanate was synthesized by combining lithium carbonate (Li₂CO₃) and titanium dioxide (TiO₂) in stoichiometric proportions. The mixture was calcined at approximately 750 °C for about two hours in air, crushed, and further annealed at approximately 850 °C for about four hours. The resulting powder was screened through a 200-mesh sieve to obtain uniform particle size.

### Example 4—Precipitation-Based Synthesis of Lithium Titanate

Spinel Li₄Ti₅O₁₂ was prepared via a low-temperature precipitation process using titanium alkoxide and lithium hydroxide precursors. The reactants were mixed under cooled conditions, producing a precipitate that was collected by centrifugation and washed to neutral pH. The dried powder was annealed at approximately 700 °C for about twelve hours to yield crystalline lithium titanate.

### Example 5—Synthesis of Graphene Oxide and Reduced Graphene

Graphite powder was oxidized using an acid-permanganate process to produce graphite oxide, followed by peroxide quenching and repeated washing. Graphite oxide was dispersed in water and chemically reduced using hydrazine hydrate at elevated temperature to form graphene oxide and reduced graphene. The product was washed and vacuum dried.

### Example 6—Preparation of Graphene-Coated Lithium Titanate Anode

Lithium titanate precursor powder was dispersed in aqueous solution containing graphene oxide and hydrazine hydrate and subjected to ultrasonic agitation.

The mixture was refluxed at approximately 95 °C for about 24 hours. The resulting composite powder was filtered, washed, dried, and annealed at approximately 700 °C under an inert atmosphere to yield graphene-coated Li₄Ti₅O₁₂.

### Example 7—Preparation of Carbon-Coated Lithium Titanate

A procedure analogous to Example 6 was employed, except carbon powder was substituted for graphene oxide to produce carbon-coated lithium titanate composite material.

### Example 8—Wet Chemical Synthesis of NMC811 Cathode

Lithium, nickel, manganese, and cobalt salts were dissolved in aqueous solution and combined with organic chelating agents. The mixture was heated to form a viscous gel, dried, pelletized, and thermally treated at intermediate and high temperatures under oxygen flow to yield LiNi_{0.8}Mn_{0.1}Co_{0.1}O₂ (NMC811).

### Example 9-Synthesis of Garnet-Type Solid Electrolytes

Gallium-doped lithium lanthanum zirconate (Li₇₋₃ₓGaₓLa₃Zr₂O₁₂) powders were synthesized by solid-state reaction of lithium carbonate, lanthanum oxide, zirconium oxide, and gallium oxide, followed by ball milling, calcination, pellet pressing, and sintering at approximately 1100 °C.

### Example 10—Sol-Gel Synthesis of LLZO and Ta-Doped LLZO

Lithium, lanthanum, zirconium, and tantalum precursors were dissolved in aqueous or non-aqueous polymer-assisted sol-gel systems. Chelation agents and polymer binders were employed to produce homogeneous precursor solutions, which were dried, calcined, and ground to produce garnet electrolyte nanopowders.

### Example 11—Calcination and Powder Processing

Precursor powders were dried at temperatures between approximately 80 °C and 120 °C, followed by calcination at temperatures between approximately 600 °C and 800 °C. The resulting powders formed low-density foams that were gently ground to produce free-flowing nanopowders.

### Example 12—Pellet Formation and Sintering

Electrolyte powders were uniaxially pressed into pellets at pressures of approximately 500 MPa. Pellets were embedded in mother powder and lithium peroxide and sintered at approximately 1100 °C to minimize lithium volatilization and promote densification.

TABLE 1
The table below summarizes the performance metrics of
the developed batteries against the four tenants.

| Tenant | P3M Specification | Developed Battery Metrics | Justification |
|---|---|---|---|
| Safety | Lithium safe | Compliant with safety | Passed P9290 |
| | | standards | implodable/ |
| | | | explodable testing |
| | | | with no thermal events |
| Capacity (Ah) | 37.2 | 52.5 | Enhanced cathode loading |
| | | | and high electrode density |
| Charge/Discharge | 1 C | 0.5 C | Stable cycling with minimal |
| | | | degradation; cathode |
| | | | kinetics under optimization |
| Weight (kg) | 6 kg (Battery case + | 4 kg Battery Case + 4.4 | Lightweight construction |
| | Battery Pack) | kg Battery pack | and high gravimetric |
| | | | energy density |

The powder X-ray diffraction patterns were recorded using a Rigaku Ultima IV diffractometer (X-ray Target Cu Kα (1.5408 A), 40 kV and 44 mA, Bragg-Brentano geometry, 10-sample stage/reflection mode, 10 to 70 degrees, 0.05 degrees/step, 2 degrees/minutes). Thermogravimetry analysis (TGA) was performed using a TGA-7 Perkin-Elmer instrument analyzer to monitor the weight loss/gain and heat treatment processes under a flow of Nitrogen gas with a 10 °C/min heating rate. Measurements were conducted in the temperature range of 25≤T≤1000 °C. The morphologies and the distribution of grain size were determined by using a scanning electron microscope and transmission electron microscopy. Raman spectra of the materials were measured using a RAMAN Imaging System WITec alpha300R spectrometer with a solid-state laser operating at 532 nm over the 1000 to 3000 cm⁻¹ range.

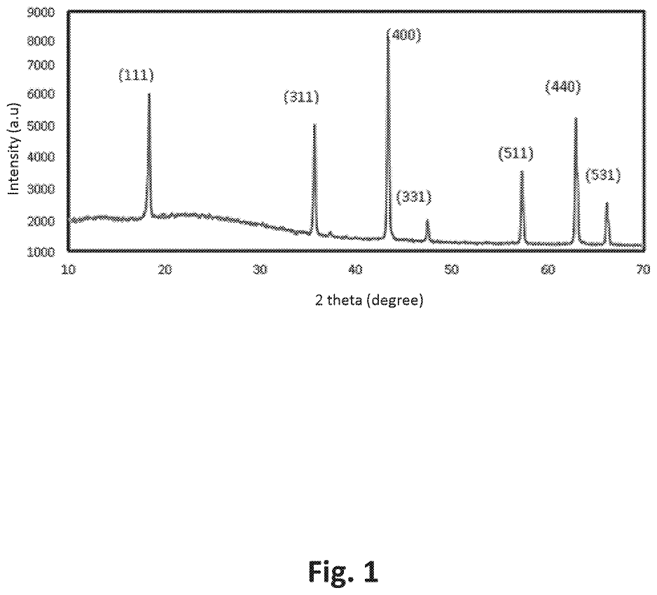

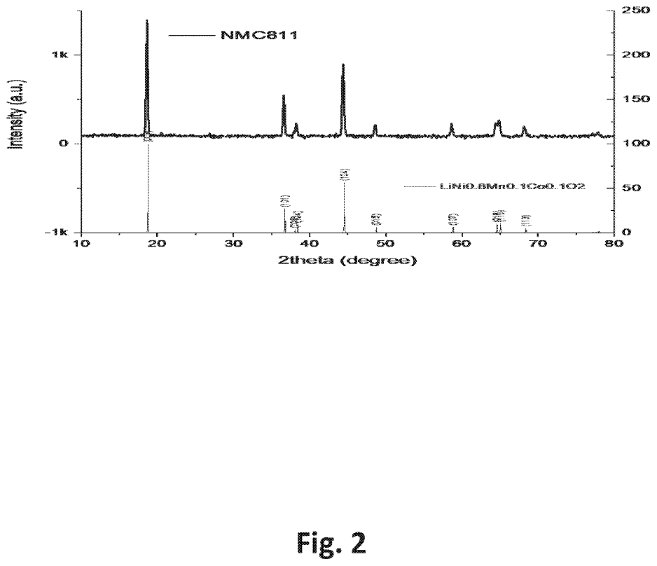

FIG. 1 shows the XRD patterns of the pure phase of the spinel L₄Ti₅O₁₂ annealed at 850 °C for 4 hours. XRD patterns provided the main peaks of the L₄Ti₅O₁₂ phase (JCPDS: 000-049-0207). FIG. 2 shows the XRD patterns of the LiNi_{0.8}Mn_{0.1}Co_{0.1}O₂ nanostructures. The highest peak can be seen at 20 of 18.65°. There are eight main peaks that could be indexed to JCPDS card no. 09-0063, 32-0581 and 20-0781. These peaks are well matched with reference at order 2θ of 18.65°, 36.6°, 36.800°, 44.35°, 48.65°, 58.65°, 64.42° and 68.15° with miller index of (003); (101); (006); (104); (015); (107); (110); and (113), respectively. The value of 20 and full width at half maximum (FWHM) based on XRD characterization could be used to determine the crystallite size (DXRD) of LiNi0.8Mn0.1Co0.1O2 using Schere's equation. The calculated DXRD value is f 44.58 nm.

### Optimization of Separator Wettability

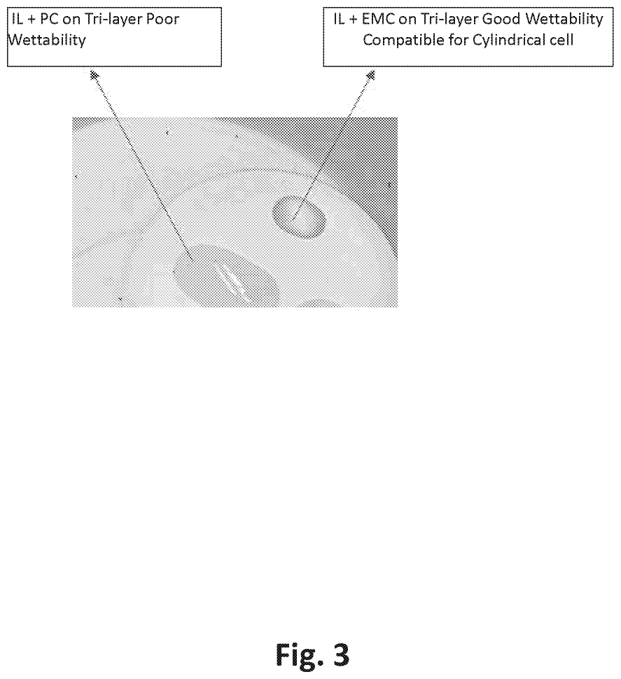

The wettability of the separators was calculated using the equation given bellow:

$$Wettability \% = \frac{( {W}_{wet} - {W}_{dry} )}{{W}_{dry}} \times 100$$

In which, W_{wet} is the weight of the separator after absorbing the quasi-solid-state electrolyte, and W_{dry} is the weight of the separator before treating it with the quasi-solid-state electrolyte. The following (quartz, glass fiber, polyethylene, tri-layer, PVDF, and PMMA) separators were immersed in quasi-solid-state electrolyte for 6 hours, 12 hours, and 24 hours followed by weighing the separators. Based on wettability calculations, the tri-layer separator in a quasi-solid-state electrolyte with a combination of ethyl methyl carbonate (EMC) additive shows good wettability (FIG. 3).

### Preparation of Electrodes for Pouch Cells

### Example 13: Preparation of Battery Components for Pouch-Cell Fabrication

The graphite/anode (90 wt. % active materials: 5 wt. % super: 5 wt. % binder) was cut into rectangular pieces using a cutting machine. The cathode material (NMC811) (90 wt. % active materials: 5 wt. % super: 5 wt. % PVDF binder) was cut into rectangular pieces of the same size as the anode foil. Prepared the electrolyte (80 wt. % RTIL and 20 wt. % EMC, 0.5 wt. % clay) solution by mixing with a magnetic stirrer in a glass baker inside the argon gas filled glovebox.

### Example 14: Assembly of Pouch Cell

The anode material was placed on the bottom of the pouch cell assembly jig. The cathode material was placed on top of the anode foil, making sure it is centered. Added a few drops of electrolyte solution to the cathode material. A tri-layer separator was placed on top of the cathode material. Place a rectangular piece of stainless-steel mesh on top of the separator. The pouch cell cover was placed on top of the stainless-steel mesh, and the tool kit was used to crimp the cover onto the cell.

### Example 15: Sealing the Pouch Cell

The pouch cell was transferred to the glovebox with an argon atmosphere and, the pouch cells were sealed. Place the sealed pouch cell into the vacuum oven or desiccator to remove any remaining moisture. The sealed pouch cell was stored in a dry and cool place until it was ready for use.

### Example 16: Preparation of Battery Components for Pouch-Cell Fabrication

The graphite/anode (90 wt. % active materials: 5 wt. % super: 5 wt. % binder) was cut into rectangular pieces using a cutting machine. The cathode material (NMC811) (90 wt. % active materials: 5 wt. % super: 5 wt. % PVDF binder) was cut into rectangular pieces of the same size as the anode foil. Prepared the electrolyte (80 wt. % RTIL and 20 wt. % EMC, 0.5 wt. % clay) solution by mixing with a magnetic stirrer in a glass baker inside the argon gas-filled glovebox.

### Example 17: Assembly of Pouch Cell

The anode material was placed on the bottom of the pouch cell assembly jig. The cathode material was placed on top of the anode foil, making sure it is centered. Added a few drops of electrolyte solution to the cathode material, being careful not to overflow. A tri-layer separator was placed on top of the cathode material. Place a rectangular piece of stainless-steel mesh on top of the separator. The pouch cell cover was placed on top of the stainless-steel mesh, and the tool kit was used to crimp the cover onto the cell.

### Example 18: Sealing the Pouch Cell

The pouch cell was transferred to the glovebox with an argon atmosphere and, then the pouch cells were sealed. Place the sealed pouch cell into the vacuum oven or desiccator to remove any remaining moisture. The sealed pouch cell was stored in a dry and cool place until it was ready for use.

### Electrode Fabrication for 18650 Cylindrical Cells

### Example 19: Preparation of Electrode Slurry

Weighed the required amount of active material (LTO/C, LFP, or NMC811), conductive carbon additive (conductive carbon C65), and binder (PVDF) in a glass beaker. Add the required amount of solvent (NMP) to the beaker and then mixed using a magnetic stir bar until a homogeneous slurry was obtained. Sonicated the slurry for 30 minutes to disperse the active material and carbon additive uniformly.

### Example 20: Coating of Substrate

The substrate (such as aluminum foil) was cleaned with isopropyl alcohol and then allowed dry. Load the substrate onto the doctor blade or spin coater. Applied the slurry onto the substrate using the doctor blade or spin coater to obtain a uniform and controlled thickness. The coated substrate was dried at 80-120 °C in an oven or under ambient conditions.

### Example 21: Calendering of Electrode

The electrode was cut into the desired size and shape and then placed between two rollers of a calendering machine and applied pressure to compress the electrode. Repeated the calendering process several times with decreasing pressure to increase the electrode density and improve its electrochemical performance.

### 18650 Cylindrical-Cell Fabrication

### Example 22: Preparation of Battery Components for Cylindrical Cell Fabrication

Active materials coated—The length and width of the rolls (including coated and uncoated areas) were 10 m and, the foil width is 290 mm total (max coated area is 280 mm wide). The coated rolls were cut into the required dimensions based on the cell size. For NMC811 electrodes (90% active, 5% Super P, & 5% PVDF), up to 25 mg/cm² (double-sided loading) was coated on Al foil. LTO/C (85% active: 10% Super P: 5% PVDF) and LFP (88% active: 8% Super P: 4% PVDF) electrodes were slightly coated beyond 25 mg/cm² (double-sided loading) on Cu and Al rolls. For graphite electrodes, a loading of up to 13-15 mg/cm² (double-sided loading). The reason for this loading is due to the graphite capacity compared to the cathodes. (372 mAh/g for graphite, cathode capacity ~160 mAh/g). The separator was cut into a circular shape to match the diameter of the metal can. Prepared the electrolyte (80 wt. % RTIL and 20 wt. % EMC, 0.5 wt. % clay) solution by mixing with a magnetic stirrer in a glass baker inside the argon gas-filled glovebox.

### Example 23: Assembly of Cylindrical Cell

The insulation washer was placed on the bottom of the metal can. Inserted the rolled electrode assembly into the metal can, making sure it is centered and in contact with the insulation washer. Added a few drops of electrolyte solution to the negative electrode, being careful not to overflow. The gasket was placed on top of the positive electrode, ensuring a tight fit. The top cap was placed on the gasket and pressed down to make sure it is seated properly. The top cap was welded to the metal can using a spot welder or ultrasonic welder.

### Example 24: Sealing the Cylindrical Cell

The cylindrical cell was transferred into the glovebox with an argon atmosphere. The bottom cap was welded to the metal can using a spot welder or ultrasonic welder. The sealed cylindrical cell was stored in a dry and cool place until it was ready for use.

### Example 25: Pre-Test Preparation

Arbin Instrument was identified as an appropriate test equipment to perform electrochemical tests. Ensured the test environment meets the temperature, humidity, and other conditions. All necessary safety equipment and precautions were in place before starting the testing. A Class D (powder-based) fire extinguisher is mandatory for battery testing. Ensured no flammable objects are around the test chamber.

### Example 26: Capacity Testing

Charged the cell fully to 100% capacity using a constant supply of D.C. current with a 1 C-rate based on the cathode active materials mass. Discharge the cell at a constant current of 1 C until the cell voltage reaches the cut-off voltage. Recorded the discharge time, voltage, and current data in a spreadsheet. Calculated the cell capacity by multiplying the discharge current by the discharge time. Repeated the capacity test three times to obtain an average capacity value.

### Example 27: Temperature Testing

The cylindrical cell was placed in a temperature chamber at 0 °C, 20 °C, and 50 °C during charging and discharging. Recorded the cell voltage, temperature, and capacity data in a spreadsheet. The voltage vs. capacity curve plots were plotted.

### Example 28: Cycle Life Testing

Charged the cell to 100% capacity using a battery charger with a current rate of 1 C. Discharged the cell at a constant current of 1 C until the battery voltage reached the cut-off voltage. Recharged the cell to 100% capacity. Repeat this cycle until the battery capacity drops below 80% of its original capacity. Recorded the cycle life data in a spreadsheet and then plotted the cycle life curve with respect to capacity or capacity retention.

### Pouch-Cell Fabrication

### Example 29: Preparation of Battery Components for Pouch-Cell Fabrication

The graphite/anode (90 wt. % active materials: 5 wt. % super: 5 wt. % binder) was cut into rectangular pieces using a cutting machine. The cathode material (NMC811) (90 wt. % active materials: 5 wt. % super: 5 wt. % PVDF binder) was cut into rectangular pieces of the same size as the anode foil. Prepared the electrolyte (80 wt. % RTIL and 20 wt. % EMC, 0.5 wt. % clay) solution by mixing with a magnetic stirrer in a glass baker inside the argon gas-filled glovebox.

### Example 30: Assembly of Pouch Cell

The anode material was placed on the bottom of the pouch cell assembly jig. The cathode material was placed on top of the anode foil, making sure it was centered. Added a few drops of electrolyte solution to the cathode material, being careful not to overflow. A tri-layer separator was placed on top of the cathode material. Place a rectangular piece of stainless-steel mesh on top of the separator. The pouch cell cover was placed on top of the stainless-steel mesh, and the tool kit was used to crimp the cover onto the cell.

### Example 31: Sealing the Pouch Cell

The pouch cell was transferred to the glovebox with an argon atmosphere and, the pouch cells were sealed. Place the sealed pouch cell into the vacuum oven or desiccator to remove any remaining moisture. The sealed pouch cell was stored in a dry and cool place until it was ready for use.

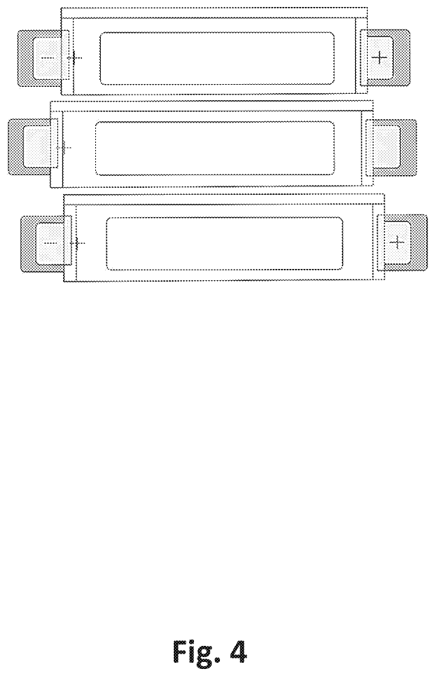

FIG. 4 shows the digital image of the pouch cells (Cell 1, Cell 2, and Cell 3) made using graphite anode/(80 wt. % RTIL and 20 wt. % EMC, 0.5 wt. % clay) electrolyte/NMC811 cathode. The cathode active materials (NMC811) loading materials was 18.450 g, and the total loading materials including conducting carbon, binder, and active materials were 20.5 g. The size of the cell is 11 cm in length and 6.5 cm in width. Three identical cells were made and stabilized with a C/10 rate. Cycle stability characterization was performed using five cycles of charge/discharge at a 1 C rate; further cycling is going on.

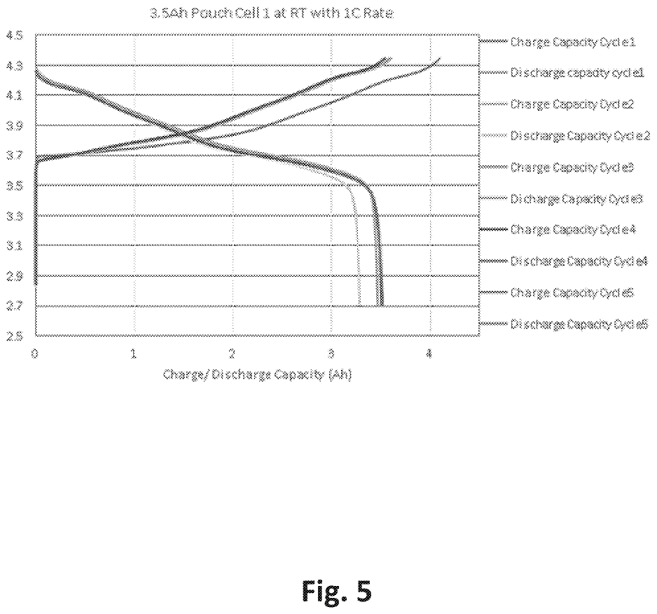

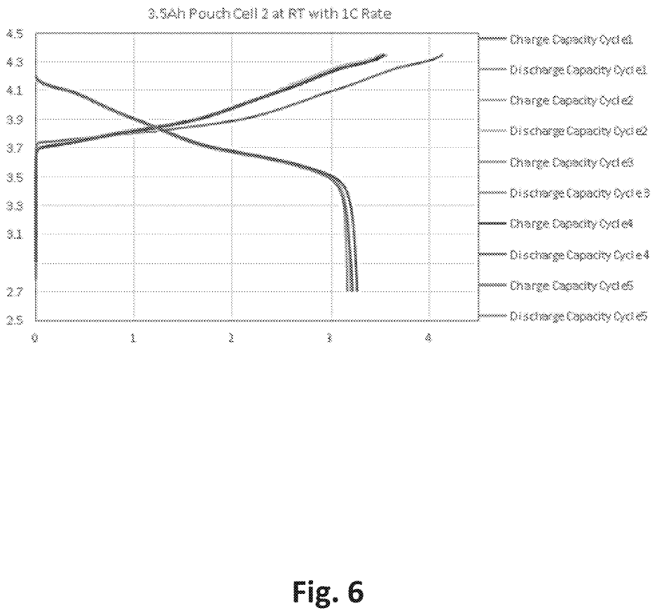

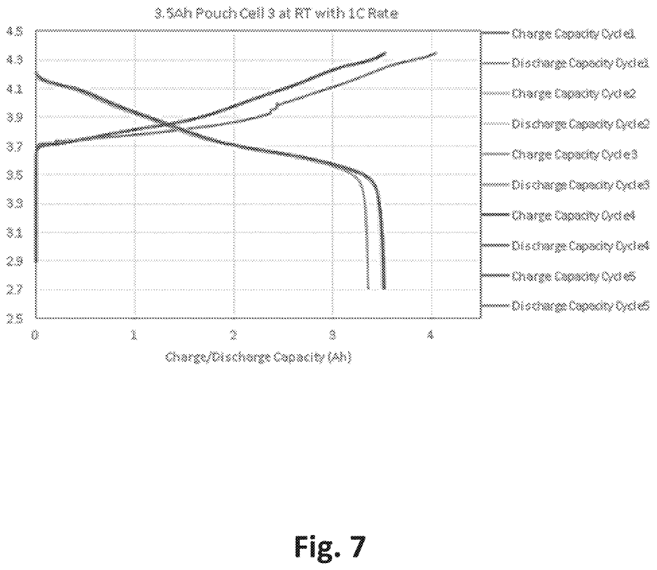

The charge/discharge profiles of 3.5 Ah (Cell 1, Cell 2, and Cell 3) pouch cells with a configuration of graphite/80% RTIL+20% EMC/NMC811 at room temperature with a 1 C rate are shown in FIGS. 5-7. The initial discharge capacity of the NMC811 electrode was 3.52 Ah (Cell 1), 3.17 Ah (Cell 2), and 3.35 Ah (Cell 3) at room temperature. The measured discharge capacities were 3.47 Ah (Cell 1),3.22 Ah (Cell 2), and 3.52 Ah (Cell 3) after 5 cycles of cells. The columbic efficiency was 101.44% (Cell 1), 101.58% (Cell 2), and 104.76% (Cell 3) after 5 cycles, which shows all cells have good cycle stability.

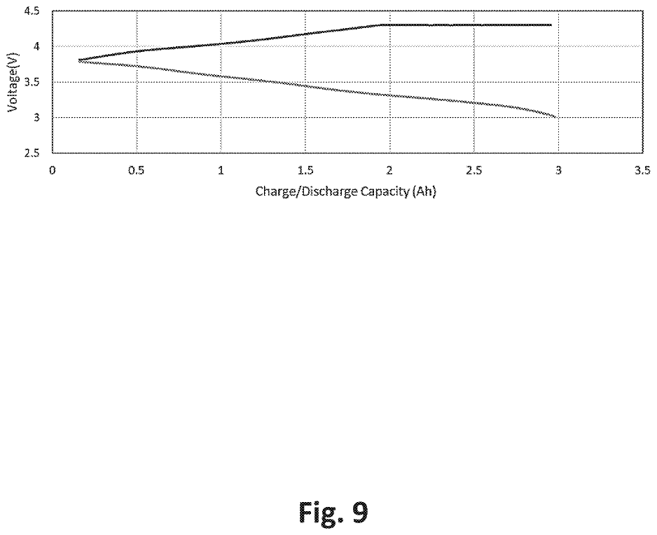

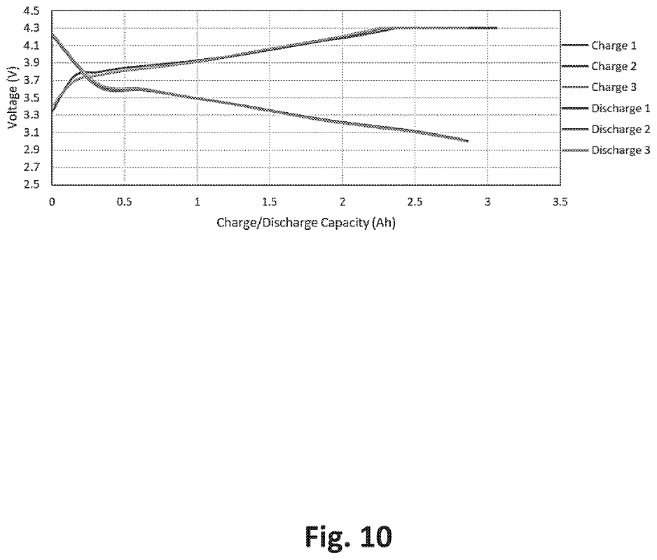

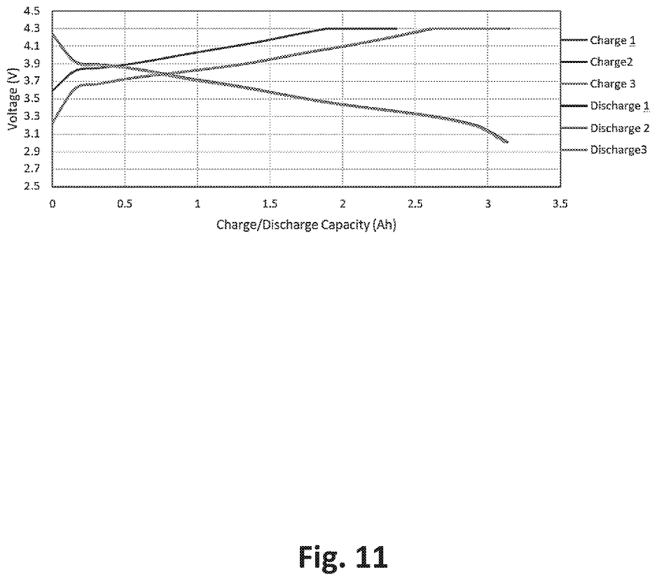

FIGS. 9-11 show the charge/discharge profiles of 3.5 Ah (Cell 1, Cell 2, and Cell 3) 18650 cells with the configuration of LTO/80% RTIL+20% EMC/NMC811 at room temperature with 1 C rate. The initial discharge capacity of NMC811 electrodes was 2.51 Ah (Cell 1), 2.87 Ah (Cell 2), and 2.85 Ah (Cell 3) at room temperature. FIG. 42 shows the cycle performance of 3.5 Ah (Cell 1, Cell 2 and Cell 3) 18650 cells at room temperature for 50 cycles. The measured discharge capacities were 2.18 Ah (Cell 1), 2.81 Ah (Cell 2), and 1.81 Ah (Cell 3) after 50 cycles of cells. The columbic efficiency was 86.85% (Cell 1), 97.91% (Cell 2), and 63.51% (Cell 3) after 50 cycles, which shows the second cell has good cycle stability.

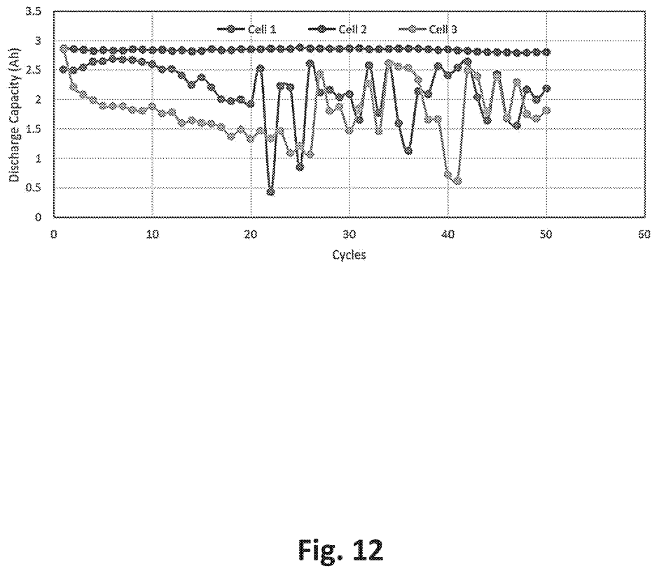

FIG. 12 shows the cycle performance of 3.5 Ah (Cell 1, Cell 2 and Cell 3) 18650 cells at room temperature for fifty cycles. The measured discharge capacities were 2.18 Ah (Cell 1), 2.81 Ah (Cell 2), and 1.81 Ah (Cell 3) after 50 cycles of cells. The columbic efficiency was 86.85% (Cell 1), 97.91% (Cell 2), and 63.51% (Cell 3) after 50 cycles, which shows the second cell has good cycle stability.

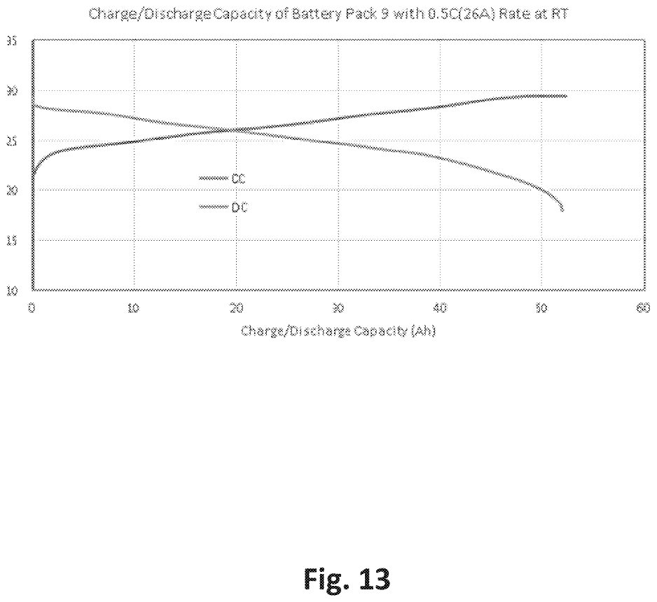

The charge/discharge profile of the 7S15P Battery Pack 9 can be found in FIG. 13. The battery pack was able to charge 52.4 Ah between 21.0 V and 29.4 V, and discharged to 52.0 Ah between 29.4 V and 17.7 V.

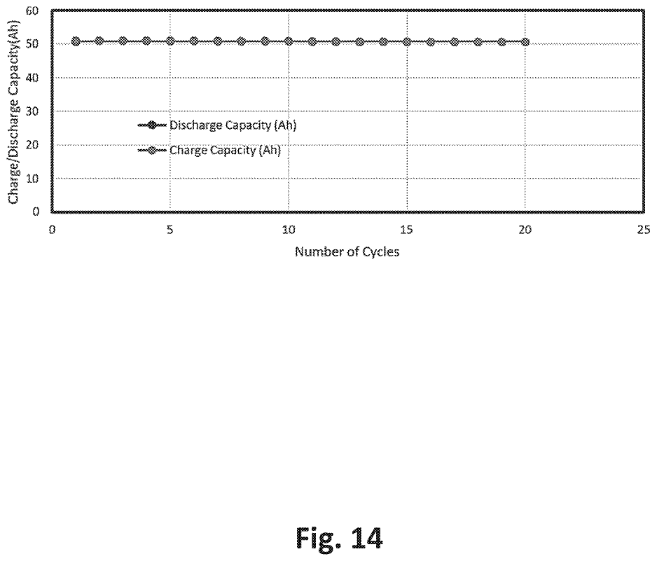

FIG. 14 shows the cycle performance of 7S15P Battery Pack 9 with a 0.5 C rate at room temperature for twenty cycles. The measured discharge capacity was 50.53611 Ah after 20 cycles of the battery pack. The columbic efficiency was 99.8% after 20 cycles, which shows the battery pack has good cycle stability.

In certain implementations, the disclosed solid-state battery can operate under extreme temperature conditions. In certain embodiments, the disclosed solid-state battery is suitable for use in military and mission-critical equipment that may be deployed in extreme environmental conditions. During such operations, batteries may be exposed to temperatures exceeding 90 °C or falling below −35 °C. Conventional battery technologies, including existing solid-state batteries, may exhibit degraded performance, safety concerns, or operational failure under such conditions. The disclosed solid-state battery addresses these limitations by providing improved safety and operational efficiency across an extended temperature range.

In certain implementations, the disclosed solid-state batteries exhibit high energy density, for example, on the order of about 575 Wh/kg, thereby enabling extended operation in mission-critical and combat environments. In such implementations, the battery is configured to withstand and operate over a broad temperature range, including temperatures from approximately −40 °C to +150 °C, while maintaining safety and functional performance.

In certain implementations, the disclosed solid-state batteries are lithium-based batteries having a cylindrical cell profile, which provide enhanced mechanical durability and resistance to thermal events. In such implementations, the disclosed batteries incorporate an optimized cell architecture configured to achieve higher energy density and stable charge-discharge profiles with minimal performance degradation over repeated cycles. The disclosed solid-state battery may further include a compact form factor that provides a high energy-to-weight ratio. By way of example, a battery assembly may include a battery case weighing approximately 4 kg and a battery pack weighing approximately 4.4 kg, without limiting the scope of the present invention.

In certain embodiments, the electrolyte comprises a composite quasi-solid-state matrix including: a polymer matrix in an amount of about 35 wt. % to about 55 wt. %, a lithium salt in an amount of about 10 wt. % to about 20 wt. %, an ionic liquid or plasticizer in an amount of about 20 wt. % to about 40 wt. %, a clay or ceramic nanofiller in an amount of about 2 wt. % to about 8 wt. %, and optionally an interfacial additive package in an amount of about 1 wt. % to about 5 wt. %.

The polymer matrix may comprise one or more polymers selected from poly(vinylidene fluoride-co-hexafluoropropylene) (PVDF-HFP), polyethylene oxide (PEO), polyacrylonitrile (PAN), polymethyl methacrylate (PMMA), and blends or copolymers thereof, including PEO/PVDF-HFP blends and PMMA/PVDF-HFP blends.

The lithium salt may comprise one or more lithium salts selected from lithium bis(fluorosulfonyl)imide (LiFSI), lithium bis(trifluoromethanesulfonyl)imide (LiTFSI), lithium hexafluorophosphate (LiPF₆), and combinations thereof.

The ionic liquid or plasticizer may comprise one or more ionic liquids selected from pyrrolidinium-based, imidazolium-based, or ammonium-based ionic liquids, including but not limited to N-butyl-N-methylpyrrolidinium bis(trifluoromethanesulfonyl)imide (PYR₁₄TFSI), N-propyl-N-methylpyrrolidinium bis(fluorosulfonyl)imide (PYR₁₃FSI), 1-ethyl-3-methylimidazolium (EMIM TFSI), and 1-butyl-3-methylimidazolium bis(trifluoromethanesulfonyl)imide (BMIM TFSI), or mixtures thereof.

The clay or ceramic nanofiller may comprise layered silicates, nanotubular clays, or oxide particulates, including but not limited to montmorillonite (MMT), laponite, halloysite nanotubes (HNT), bentonite, alumina (Al₂O₃), silica (SiO₂), or combinations thereof.

In some embodiments, the interfacial additive package comprises one or more components configured to enhance electrode-electrolyte interface stability, reduce interfacial resistance, and improve cycling performance, including lithium nitrate (LiNO₃), fluoroethylene carbonate (FEC), vinylene carbonate (VC), or other film-forming or SEI-modifying additives.

These examples are non-limiting; various modifications and changes may be made without departing from the broader spirit and scope of the invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A quasi-solid-state lithium electrolyte composition, comprising:
a room-temperature ionic liquid (RTIL);
a lithium salt dissolved in the RTIL;
a clay additive dispersed in the RTIL; and
an organic carbonate diluent comprising ethyl methyl carbonate (EMC),
wherein the composition forms a quasi-solid electrolyte mixture, and
wherein the inclusion of the EMC diluent improves wetting of a separator relative to a corresponding composition without the EMC diluent.

2. The composition of claim 1, wherein the RTIL comprises a piperidinium-based ionic liquid.

3. The composition of claim 2, wherein the RTIL comprises 1-methyl-1-propylpiperidinium bis(trifluoromethylsulfonyl)imide.

4. The composition of claim 1, comprising about 20 wt. % ethyl methyl carbonate (EMC) and about 0.5 wt. % clay additive.

5. The composition of claim 1, wherein the clay additive comprises bentonite clay.

6. The composition of claim 3, comprising:
about 80 wt. % 1-methyl-1-propylpiperidinium bis(trifluoromethylsulfonyl)imide;
about 20 wt. % ethyl methyl carbonate (EMC); and
about 0.5 wt. % clay additive.

7. The composition of claim 1, wherein the composition exhibits non-Newtonian rheological behavior and forms a viscous, gel-like electrolyte having a viscosity greater than that of the RTIL alone, and wherein the clay additive and the organic carbonate diluent cooperate to form a stable quasi-solid network that enables retention of the electrolyte within a porous separator while maintaining ionic transport.

8. The composition of claim 1, wherein the composition exhibits:
an ionic conductivity of at least 1×10⁻⁴ S/cm at 25 °C, and
a reduced interfacial resistance at an electrode-electrolyte interface relative to a corresponding electrolyte composition without the organic carbonate diluent.

9. A cylindrical lithium battery cell, comprising:
an anode;
a cathode;
a separator disposed between the anode and the cathode; and
a quasi-solid-state electrolyte disposed in ionic communication with the anode and the cathode, the quasi-solid-state electrolyte comprising:
a room-temperature ionic liquid (RTIL);
a lithium salt dissolved in the RTIL;
a clay additive dispersed in the RTIL; and
an organic carbonate diluent comprising ethyl methyl carbonate (EMC),
wherein the separator comprises a tri-layer polymer separator, and
wherein the cylindrical lithium battery cell is configured in an 18650 format.

10. The cylindrical lithium battery cell of claim 9, wherein the anode comprises lithium titanate (Li₄Ti₅O₁₂).

11. The cylindrical lithium battery cell of claim 10, wherein the anode comprises a carbon coating.

12. The cylindrical lithium battery cell of claim 10, wherein the anode comprises a graphene coating.

13. The cylindrical lithium battery cell of claim 9, wherein the cathode comprises LiNi_{0.8}Mn_{0.1}Co_{0.1}O₂.

14. The cylindrical lithium battery cell of claim 9, wherein the RTIL comprises 1-methyl-1-propylpiperidinium bis(trifluoromethylsulfonyl)imide.

15. A lithium battery system, comprising:
an anode comprising lithium titanate (Li₄Ti₅O₁₂);
a cathode comprising LiNi_{0.8}Mn_{0.1}Co_{0.1}O₂;
a separator; and
a quasi-solid-state electrolyte comprising:
a room-temperature ionic liquid (RTIL);
a lithium salt dissolved in the RTIL;
a clay additive dispersed in the RTIL; and
an organic carbonate diluent comprising ethyl methyl carbonate (EMC),
wherein the system is configured to operate under charge-discharge cycling at a plurality of temperatures, including approximately room temperature, approximately 0 °C, and approximately 80 °C.

16. The lithium battery system of claim 15, wherein the system exhibits Coulombic efficiency greater than about 99%.

17. The lithium battery system of claim 15, wherein the system maintains stable cycling performance over a temperature range from about 0 °C to about 80 °C.

18. The lithium battery system of claim 15, wherein the electrolyte comprises:
about 80 wt. % 1-methyl-1-propylpiperidinium bis(trifluoromethylsulfonyl)imide;
about 20 wt. % ethyl methyl carbonate (EMC); and
about 0.5 wt. % clay additive.
